(19) United States
(12) Patent Application Publication
(10) Pub. No.: US 2022/0009050 A1
(43) Pub. Date: Jan. 13, 2022

(54) FIBER OPTIC CONNECTOR FABRICATION CARRIER

(71) Applicant: COMMSCOPE TECHNOLOGIES LLC, Hickory, NC (US)

(72) Inventors: Mark D. NARUM, Minnetonka, MN (US); Richard William BRUNEAU, Apple Valley, MN (US); Aaron B. DANNEN, Minnetonka, MN (US); Peter J. EKOLA, Minneapolis, MN (US); Andrew G. SCHMIDT, Northfield, MN (US); Marlon E. HOLMQUIST, St. Peter, MN (US); Laurens Izaäk VAN WUIJCKHUIJSE, Eden Prairie, MN (US); Samuel Taylor FINNEGAN, Eden Prairie, MN (US); Lawrence Joseph SORENSON, Bloomington, MN (US)

(21) Appl. No.: 17/484,630

(22) Filed: Sep. 24, 2021

Related U.S. Application Data
(63) Continuation of application No. PCT/US2020/024688, filed on Mar. 25, 2020.
(60) Provisional application No. 62/826,546, filed on Mar. 29, 2019.

(51) Int. Cl. B24B 19/22; G02B 6/38

(52) U.S. Cl. CPC B24B 19/226; G02B 6/3863

(57) ABSTRACT

A fabrication carrier for fiber optic connectors defines a body configured to removably hold a plurality of fiber optic ferrules. The body allows each of the fiber optic ferrules to be movable along its axis under a bias when the ferrules are mounted to the body. The body can be coupled to a polishing plate for use with a ferrule polishing apparatus in a polishing step. Coupling of the body to the polishing plate allows each of the ferrules to at least partially protrude past a bottom face of the polishing plate for contact with the polishing apparatus. The body of the fabrication carrier is configured as a fixture that can be used in at least one additional fabrication step aside from the polishing step when not mounted to the polishing plate.

### CROSS-REFERENCE TO RELATED APPLICATION

This application is a continuation of PCT/US2020/024688, filed on Mar. 25, 2020, which claims the benefit of U.S. Patent Application Ser. No. 62/826,546, filed on Mar. 29, 2019, the disclosures of which are incorporated herein by reference in their entireties. To the extent appropriate, a claim of priority is made to each of the above disclosed applications.

### BACKGROUND

As demand for telecommunications increases, fiber optic networks are being extended into more and more areas. As a result, there is a need for manufacturing efficiencies including for the fixtures and methods used in the development of fiber optic devices such as fiber optic connectors.

### SUMMARY

An aspect of the present disclosure relates to fixtures used in the manufacture of fiber optic devices such as fiber optic connectors. One particular aspect relates to a fiber optic connector carrier that serves as a fixture to be used in one or more of the manufacturing steps in the securing and termination of optical fibers to fiber optic connectors. The connector carrier is provided as a traveling fixture that can be moved around within a manufacturing facility among the different stations for terminating the optical fibers and forming the fiber optic connectors.

According to one aspect, the disclosure is directed to a fiber optic connector fabrication carrier. The fabrication carrier defines a body configured to removably hold a plurality of fiber optic ferrules. The body allows each of the fiber optic ferrules to be movable along its axis under a bias when the ferrules are mounted to the body. The body can be coupled to a polishing plate for use with a ferrule polishing apparatus in a polishing step. Coupling of the body to the polishing plate allows each of the ferrules to at least partially protrude past a bottom face of the polishing plate for contact with the polishing apparatus. The body of the fabrication carrier is configured as a fixture that can be used in at least one additional fabrication step aside from the polishing step when not mounted to the polishing plate.

Another aspect of the present disclosure relates to a polishing fixture for use with a fiber optic ferrule polishing apparatus in a polishing step, the polishing fixture comprising a polishing plate defining a bottom face directed toward a grinding film of the polishing apparatus. The polishing fixture further includes a fabrication carrier for fiber optic connectors, the carrier comprising a body removably mounted to the polishing plate. The carrier is configured to removably hold a plurality of fiber optic ferrules, the body of the carrier allowing each of the fiber optic ferrules to be movable along its axis under a bias when the ferrules are mounted to the body, wherein when the fiber optic ferrules have been mounted to the carrier, each of the fiber optic ferrules at least partially protrude past the bottom face of the polishing plate for contact with the polishing apparatus.

According to another aspect of the disclosure, a polishing plate for use on a polishing fixture of a polishing apparatus comprises a top face and an opposing bottom face configured to be directed toward a grinding film of the polishing apparatus. A recess is exposed on the top face for receiving a body of a fabrication carrier removably holding a plurality of fiber optic ferrules. A plurality of discrete ferrule sleeves are defined within the recess, the ferrule sleeves configured to receive and allow the fiber optic ferrules to at least partially protrude past the bottom face of the polishing plate for contact with the grinding film of the polishing apparatus.

According to yet another aspect, the disclosure is directed to a fiber optic connector fabrication method. The method comprises at least removably coupling a connector carrier to a polishing plate, wherein the polishing plate defines a top face and an opposing bottom face configured to be directed toward a grinding film of a polishing apparatus and a recess exposed on the top face for receiving the connector carrier. The connector carrier holds a plurality of fiber optic ferrules, the connector carrier allowing each of the fiber optic ferrules to be movable along its axis under a bias, wherein when the connector carrier is coupled to the polishing plate, each of the fiber optic ferrules at least partially protrudes past the bottom face of the polishing plate for contact with the grinding film of the polishing apparatus.

A variety of additional inventive aspects will be set forth in the description that follows. The inventive aspects can relate to individual features and combinations of features. It is to be understood that both the foregoing general description and the following detailed description are exemplary and explanatory only and are not restrictive of the broad inventive concepts upon which the embodiments disclosed herein are based.

### BRIEF DESCRIPTION OF THE DRAWINGS

FIG. 1 is a top perspective view of a fiber optic connector carrier having features that are examples of inventive aspects in accordance with the present disclosure, the connector carrier configured to be used as a mobile or traveling fixture in one or more of the manufacturing steps in the termination of optical fibers to fiber optic connectors;

FIG. 2 is a top view of the connector carrier of FIG. 1;

FIG. 3 is a side view of the connector carrier of FIG. 1;

FIG. 4 is an end view of the connector carrier of FIG. 1;

FIG. 5 illustrates the connector carrier of FIGS. 1-4 in a partially disassembled configuration, illustrating the internal features thereof;

FIG. 6 illustrates the connector carrier of FIG. 5 in a fully disassembled configuration;

FIG. 7 is a top perspective view of a base portion of the fiber optic connector carrier of FIGS. 1-6;

FIG. 8 is a top view of the base portion of FIG. 7;

FIG. 9 is a bottom view of the base portion of FIG. 7;

FIG. 10 is a side view of the base portion of FIG. 7;

FIG. 11 is a top perspective view of a cover portion of the fiber optic connector carrier of FIGS. 1-6;

FIG. 12 is a top view of the cover portion of FIG. 11;

FIG. 13 is a bottom view of the cover portion of FIG. 11;

FIG. 14 is a side view of the cover portion of FIG. 11;

FIG. 15 is a top perspective view of one of the latch inserts to be placed within the base portion of the fiber optic connector carrier of FIGS. 1-6, the latch insert shown without its coil springs;

FIG. 16 is a top view of the latch insert of FIG. 15;

FIG. 17 is a side view of the latch insert of FIG. 15;

FIG. 18 is an end view of the latch insert of FIG. 15;

FIG. 19 is a top view of a conventional LC style fiber optic connector that can be manufactured using the connector carrier of FIGS. 1-6;

FIG. 20 is a cross-sectional view that longitudinally bisects the fiber optic connector of FIG. 19 for illustrating the internal features of the connector;

FIG. 21 is a partially exploded view of the connector of FIGS. 19 and 20 illustrating the front housing, the ferrule assembly, and the ferrule spring of the connector;

FIG. 22 is a top perspective view of a polishing plate that is configured for receiving the connector carrier of FIGS. 1-6 for a polishing operation;

FIG. 23 is a top view of the polishing plate of FIG. 22;

FIG. 24 is a side view of the polishing plate of FIG. 22;

FIG. 25 is a cross-sectional view taken along line 25-25 of FIG. 22;

FIG. 26 is a perspective view of a polishing fixture for use on a conventional grinding apparatus, the polishing fixture defined at least partially by the polishing plate of FIGS. 22-25;

FIG. 27 is a perspective view of one of the clamp members of the polishing fixture of FIG. 26, the clamp members configured to secure the connector carriers shown in FIGS. 1-6 to the polishing plate of FIGS. 22-25 during the polishing operation;

FIG. 28 is a perspective view of one of the clamp guides used on the polishing fixture of FIG. 26 when mounting the clamp members;

FIG. 29 illustrates the connector carrier of FIGS. 1-6 with another embodiment of a polishing plate that can be used on a different grinding apparatus;

FIG. 30 is a top perspective view of another embodiment of a fiber optic connector carrier having features that are examples of inventive aspects in accordance with the present disclosure, the connector carrier having features similar to those of the connector carrier of FIGS. 1-6, the connector carrier shown configured for LC style fiber optic connectors;

FIG. 31 is a top perspective view of the base portion of the fiber optic connector carrier of FIG. 30;

FIG. 32 is a top view of the base portion of FIG. 31;

FIG. 33 is a bottom view of the base portion of FIG. 31;

FIG. 34 is a side view of the base portion of FIG. 31;

FIG. 35 is a first end view of the base portion of FIG. 31;

FIG. 36 is a second opposing end view of the base portion of FIG. 31;

FIG. 37 is a top perspective view of the cover portion of the fiber optic connector carrier of FIG. 30;

FIG. 38 is a top view of the cover portion of FIG. 37;

FIG. 39 is a side view of the cover portion of FIG. 37;

FIG. 40 is an end view of the cover portion of FIG. 37;

FIG. 41 is a top perspective view of an SC style latch insert that can be placed within the base portion of the fiber optic connector carrier of FIG. 30, the latch insert shown without its coil springs;

FIG. 42 is a side view of the latch insert of FIG. 41;

FIG. 43 is a top view of the latch insert of FIG. 41;

FIG. 44 is an end view of the latch insert of FIG. 41;

FIG. 45 is a top perspective view of another embodiment of a latch insert that can be placed within the base portion of the fiber optic connector carrier of FIG. 30, the latch insert configured for LC style fiber optic connectors, the latch insert shown without its coil springs;

FIG. 46 is a side view of the latch insert of FIG. 45;

FIG. 47 is a top view of the latch insert of FIG. 45; and

FIG. 48 is an end view of the latch insert of FIG. 45.

### DETAILED DESCRIPTION

The present disclosure is directed generally to the manufacture of certain fiber optic devices, particularly, fiber optic connectors that are used for terminating optical fibers.

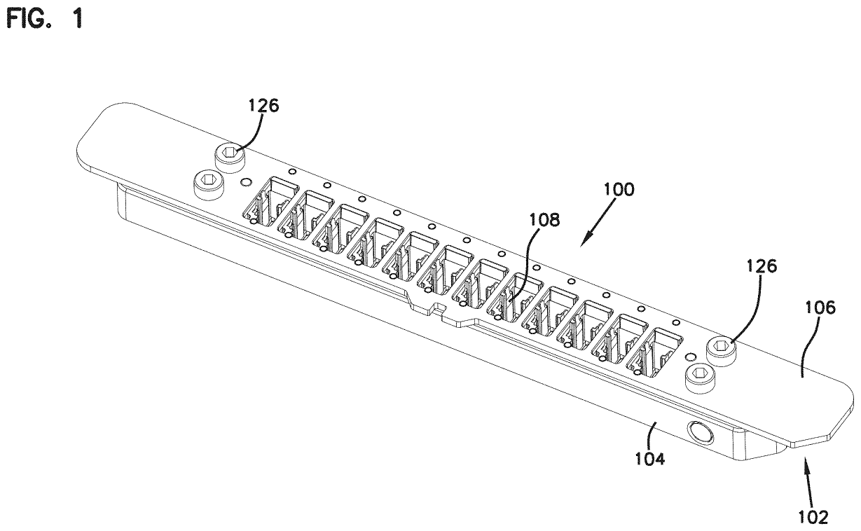

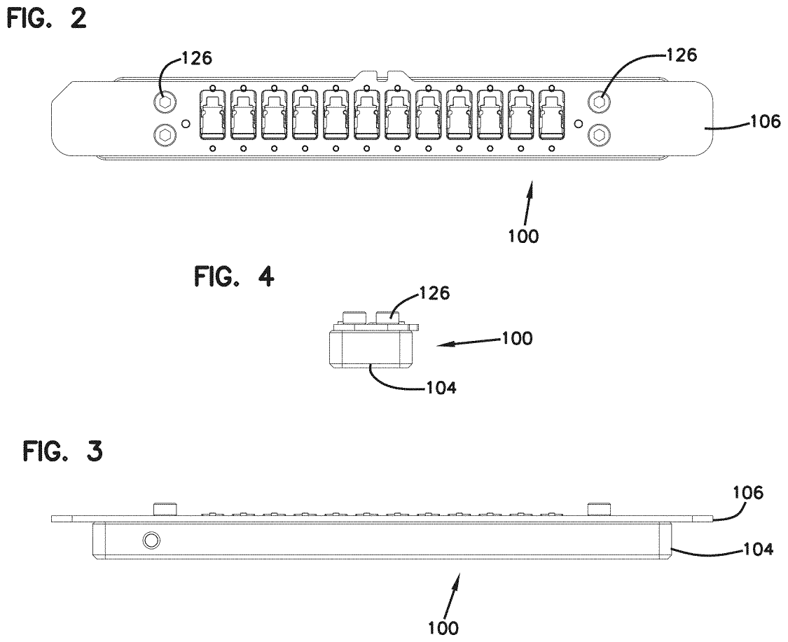

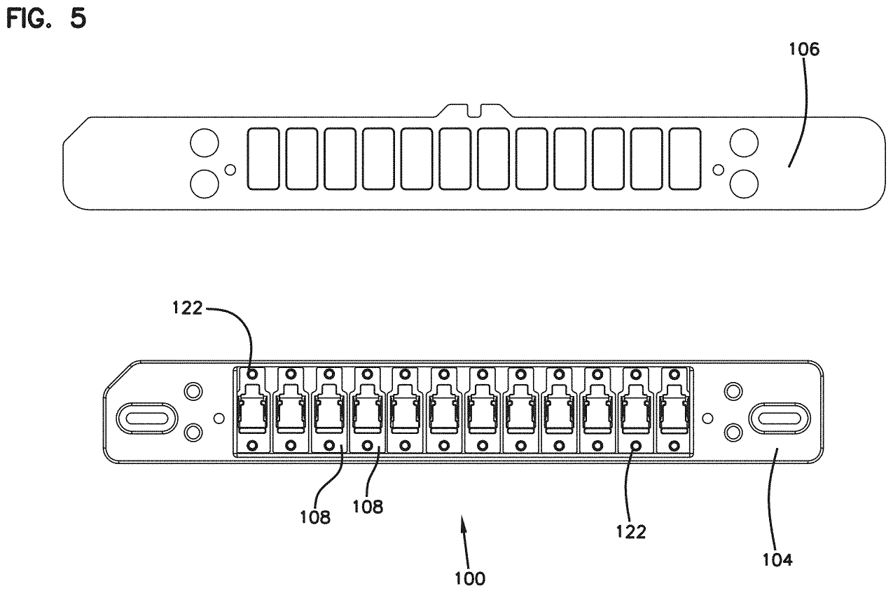

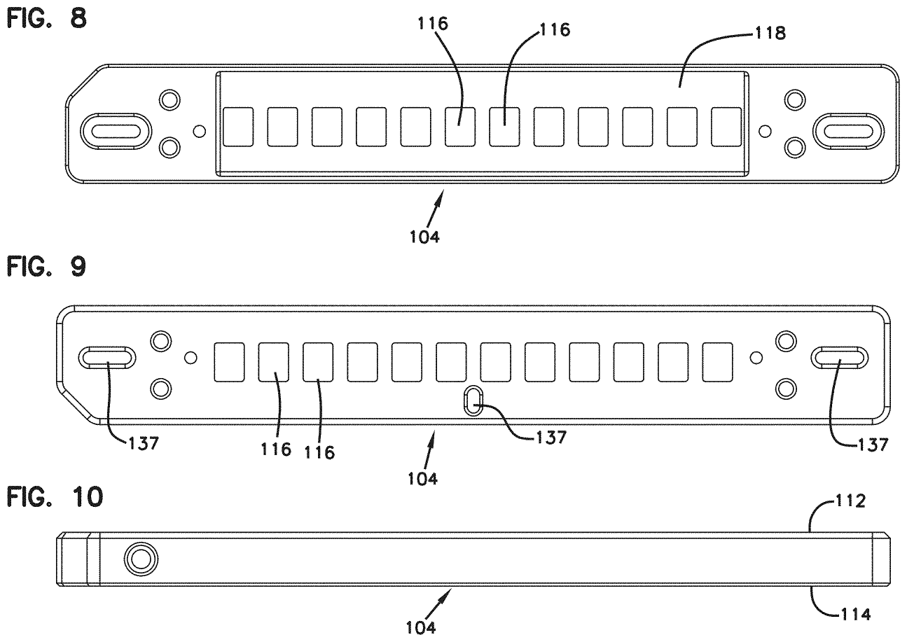

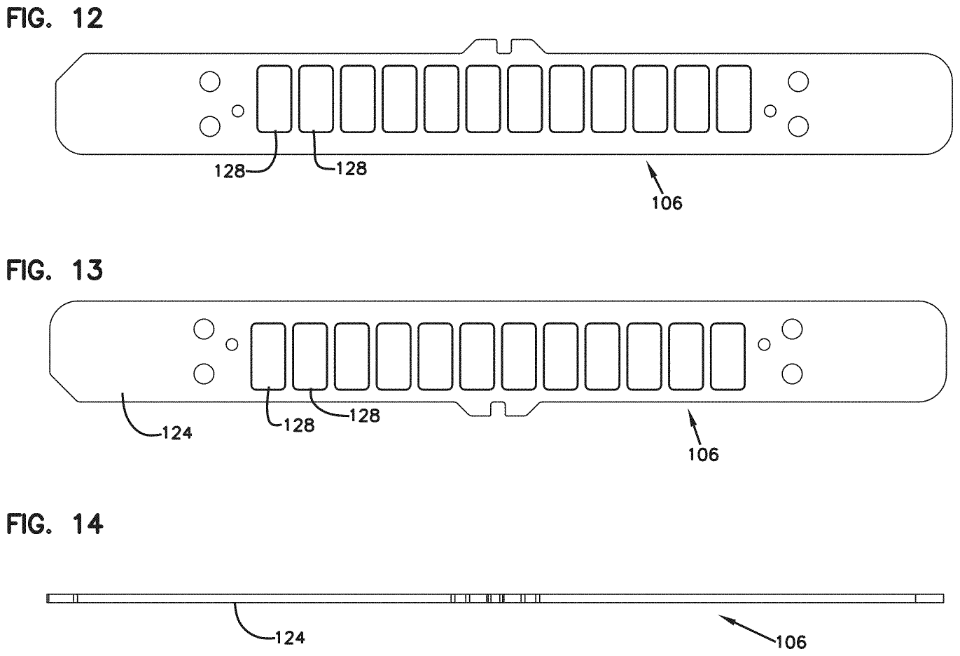

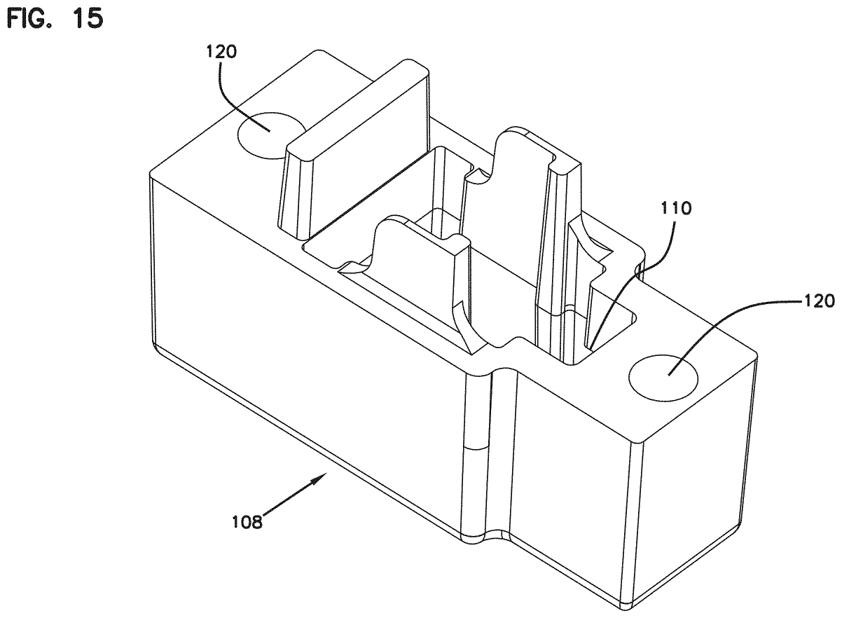

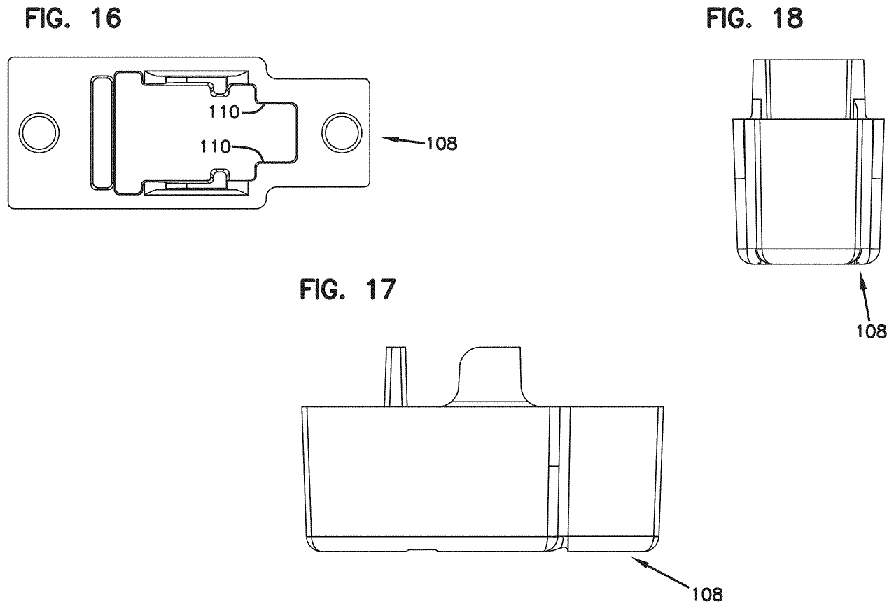

Referring to FIGS. 1-18, one particular aspect of the present disclosure relates to a fiber optic connector carrier 100 that serves as a fixture to be used in one or more of the manufacturing steps in the production of the fiber optic connectors. The connector carrier 100 is provided as a mobile or a traveling fixture that can be moved within a manufacturing facility among the different stations in terminating the optical fibers to the fiber optic connectors.

As known in the art, fiber optic connectors are generally used to align optical signals carried by opposing optical fibers via a third inter-mating structure such as a fiber optic adapter. Fiber optic adapters generally include features for selectively and removably receiving two opposing fiber optic connectors in an aligned relationship for the continuation of the optical signal.

An example fiber optic connector may define an outer housing that houses a ferrule surrounding the optical fiber. The ferrules serve as the alignment structures between two connectors and have to go through a number of processing steps at the factory level in order to improve alignment and limit signal degradation during use in the field when mating two connectors.

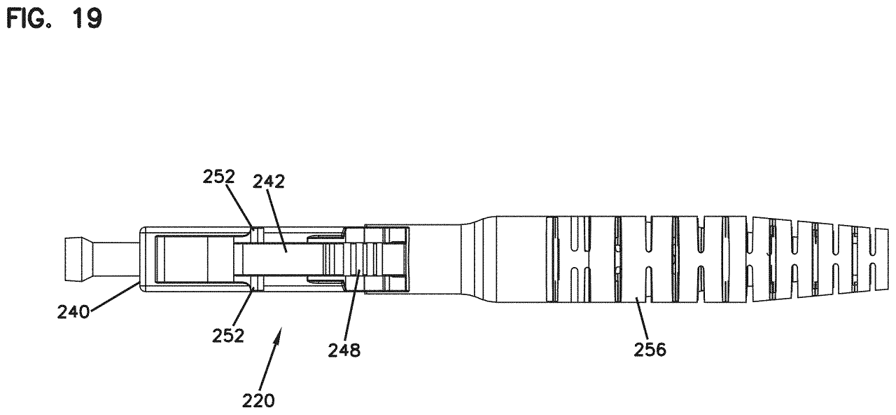

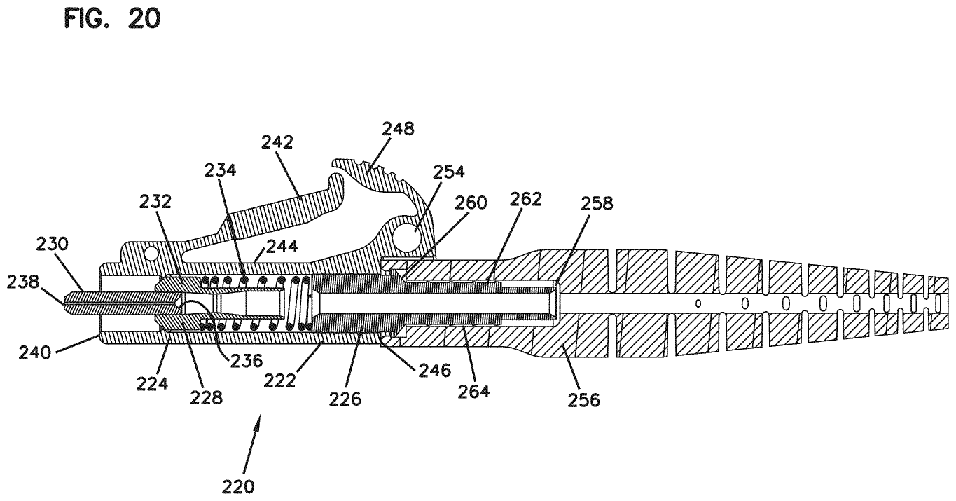

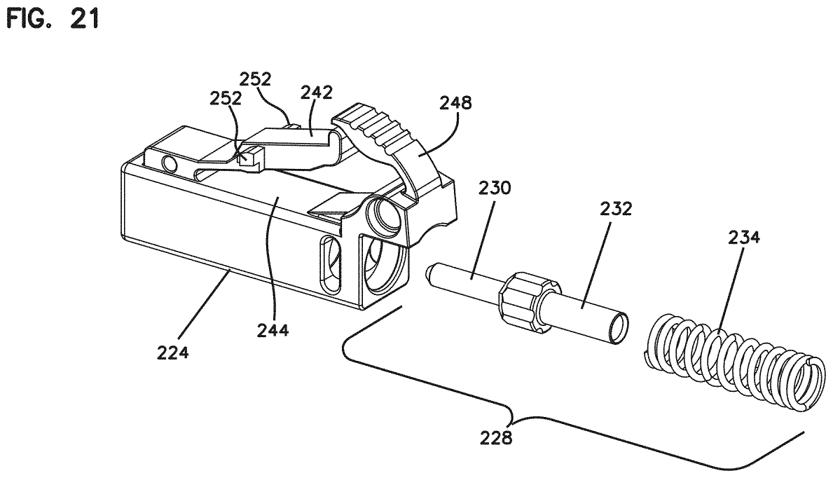

An example of a conventional fiber optic connector 220 is discussed herein with respect to FIGS. 19-21 to provide further context to the inventive nature of the connector carrier 100 of the present application.

Referring now to FIGS. 19-21, the outer housing of a fiber optic connector normally includes features to ensure fixed coupling to a matching format adapter. For example, as shown for a conventional LC style or format fiber optic connector 220 in FIGS. 19-21, a housing 222 of the connector 220 may define a front housing portion 224 and a rear housing portion 226. The LC connector 220 includes a ferrule assembly 228 defined by a ferrule 230, a hub 232, and a spring 234. A rear end 236 of the ferrule 230 is secured within the ferrule hub 232. When the LC connector 220 is assembled, the ferrule hub 232 and the spring 234 are captured between the front housing portion 224 and the rear housing portion 226 of the connector housing 222 and a front end 238 of the ferrule 230 projects forward outwardly beyond a front end 240 of the connector housing 222. The spring 234 is configured to bias the ferrule 230 in a forward direction relative to the connector housing 222.

In certain embodiments of the connector 220, the front housing portion 224 may be formed from a molded plastic. The front housing portion 224 defines a latch 242 extending from a top wall 244 of the front housing portion 224 toward the rear end 246, the latch 242 extending at an acute angle with respect to the top wall 244 of the front housing portion 224. The front housing portion 224 in the depicted embodiment also includes a latch trigger 248 that extends from the rear end 246 of the front housing portion 224 toward the front end 240. The latch trigger 248 also extends at an acute angle with respect to the top wall 244. The latch trigger 248 is configured to come into contact with the latch 242 for flexibly moving the latch 242 downwardly.

As is known in the art, when the fiber optic connector 220 is placed in an LC format adapter for optically coupling light from two optical fibers together, the latch 242 functions to lock the fiber optic connector 220 in place within the adapter. The fiber optic connector 220 may be removed from the adapter by depressing the latch trigger 248, which causes the latch 242 to be pressed in a downward direction, freeing catch portions 252 of the latch 242 from the fiber optic adapter.

A strain relief boot 256 may be slid over a rear end 258 of the rear housing portion 226 and snap over a boot flange 260 to retain the boot 256 with respect to the connector housing 222. The rear end 258 of the rear housing portion 226 defines a crimp region 262 for crimping a fiber optic cable's strength layer to the rear housing portion 226, normally with the use of a crimp sleeve. An exterior surface 264 of the rear housing portion 226 defining the crimp region 262 can be textured (e.g., knurled, ridged, provided with small projections, etc.) to assist in retaining the crimp on the housing 222.

Movement of the ferrule 230 of the LC connector in a rear direction relative to the connector housing 222 under the bias of the spring 234 causes the optical fiber to be forced/displaced in a rear direction relative to the connector housing 222 and the jacket of the fiber optic cable. The biased movement of the ferrule 230 allows for any geometry discrepancies and tolerance variations when axially mating two of the fiber optic connectors 220.

Referring now specifically to FIGS. 1-6, the connector carrier 100 having inventive aspects in accordance with the features of the present disclosure, is depicted in fully and partially assembled configurations. The connector carrier 100 depicted in FIGS. 1-6 is configured for use in manufacturing of the LC style connectors 220 (of FIGS. 19-21) discussed above.

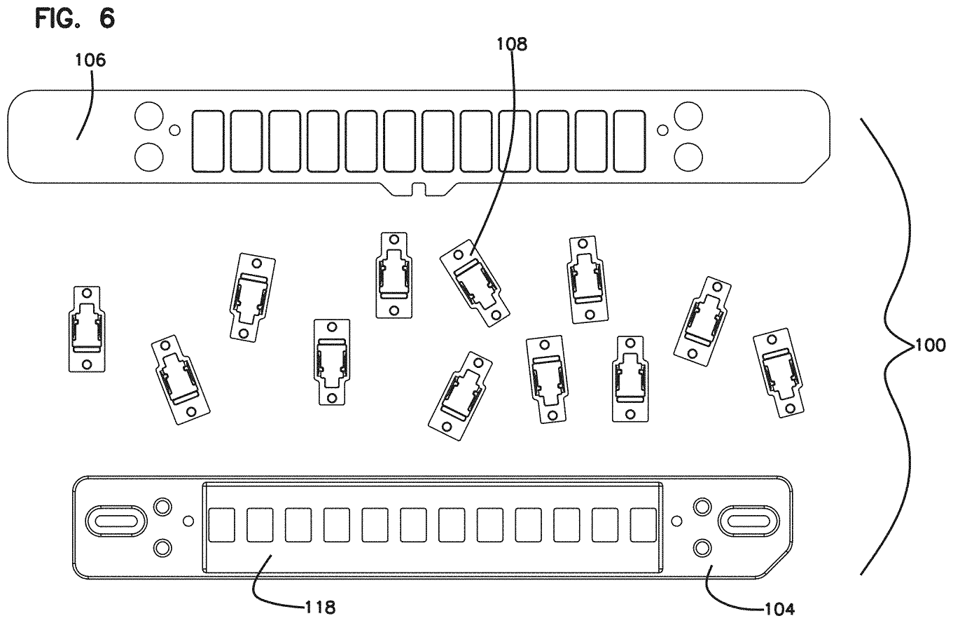

FIGS. 1-4 illustrate the connector carrier 100 in an assembled configuration. FIGS. 5-6 illustrate the connector carrier 100 in a disassembled configuration, showing the details of the internal features thereof.

Referring generally to FIGS. 1-18, the connector carrier 100 defines a body 102 that is formed from a base portion 104 and a cover portion 106 that is attached to the base portion 104 to capture a plurality of latch inserts 108 thereinbetween. One of the latch inserts 108 is shown in isolation in FIGS. 15-18. As will be discussed in further detail below, each latch insert 108 is formed or designed generally as a partial LC format adapter and defines a configuration that is similar internally to that of a conventional LC format fiber optic adapter. As such, the latch insert 108 is configured to fixedly receive a front housing portion 224 of an LC connector 220 to assist in the manufacturing process of such a connector.

Referring to FIGS. 15-18, each latch insert 108, similar to a conventional LC format adapter, defines a pair of shoulders 110 for abutting the catch portions 252 of the latch 242 of the front housing portion 224 of an LC connector 220 for latching the front housing portion 224 with a snap-fit interlock. As noted above, since the latch insert 108 is designed internally as a partial LC style adapter, the front housing portion 224 of the fiber optic connector 220 may be removed from the latch insert 108 similar to that of a conventional adapter by depressing the latch trigger 248, which causes the latch 242 to be pressed in a downward direction, freeing catch portions 252 of the latch 242 from the shoulders 110 of the latch insert 108.

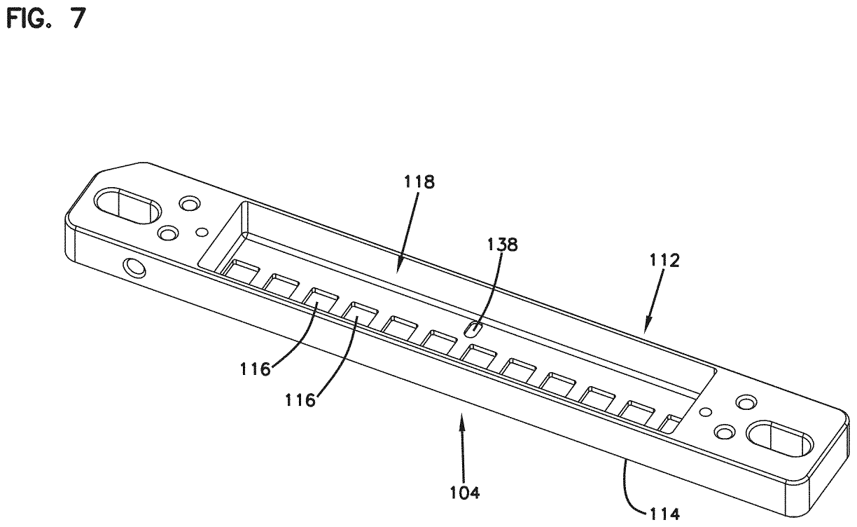

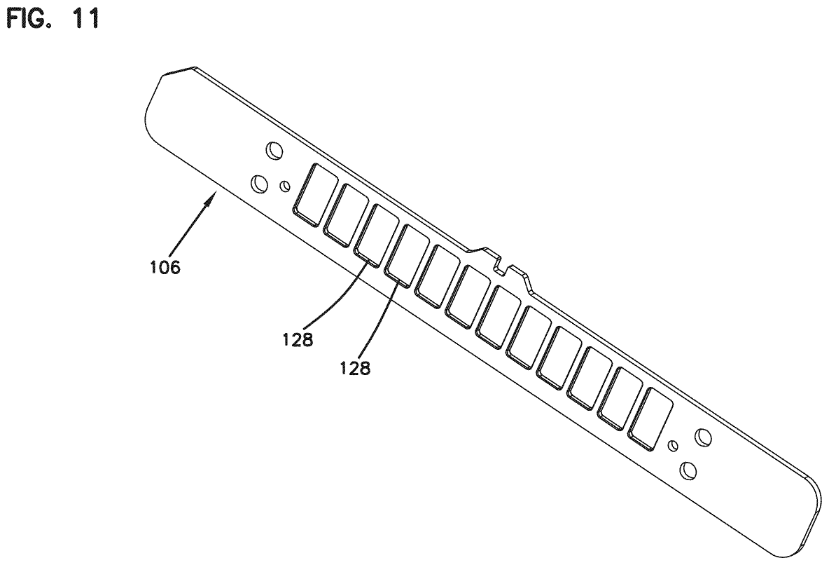

Referring now to FIGS. 7-10, the base portion 104 of the connector carrier 100 is shown in isolation. The base portion 104 defines a top side 112 and a bottom side 114. A plurality of apertures 116 are provided at the bottom side 114. A pocket 118 defined by the base portion 104 is accessible from the top side 112 and is used to receive a plurality of the latch inserts 108 (of FIGS. 15-18) discussed above. The cover portion 106 (shown in FIGS. 11-14) captures the latch inserts 108 within the pocket 118.

As shown in FIG. 5, the latch inserts 108 are provided in a horizontally stacked arrangement within the pocket 118 before being captured therein by the cover portion 106. The latch inserts 108 are provided in the pocket 118 in a generally floating configuration, biased toward the bottom side 114 of the base portion 104. As shown, each latch insert 108 defines a spring mount 120 adjacent each end that is used to receive a coil spring 122. The pair of springs 122 are configured to contact a bottom surface 124 of the cover portion 106 and allow biased axial movement for the latch inserts 108 within the pocket 118. As will be discussed in further detail below, the latch inserts 108 are provided with a biased, floatable arrangement to assist with the ferrule polishing step in the manufacture of the fiber optic connectors 220.

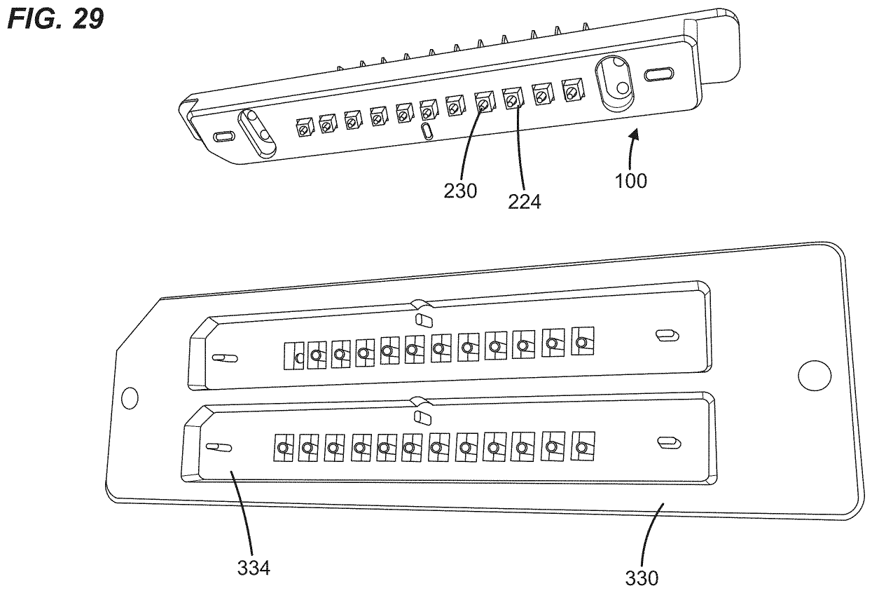

The latch inserts 108 are arranged within the pocket 118 such that a portion of the front housings 224 of the connectors 220 and the ferrules 230 protrude through the apertures 116 provided at the bottom side 114 of the carrier 100. This is shown in FIG. 29 of the present application.

The cover portion 106, shown in isolation in FIGS. 11-14, is coupled to the base portion 104 of the connector carrier 100 via a pair of fasteners 126 adjacent each side of the carrier 100 as shown in FIGS. 1-4.

Referring to FIGS. 11-14, the cover portion 106 is also provided with connector receiving apertures 128 that are designed to receive and align the front housings 224 of the LC format connectors 220 with each of the latch inserts 108 for mating therewith.

As noted above, the latch inserts 108 are provided in a generally floating configuration within the pocket 118, captured between the base portion 104 and the cover portion 106. The springs 122 on the latch inserts 108 bias or urge the latch inserts 108 downwardly toward the bottom side 114 of the base portion 104 of the carrier 100. In this manner, as will be discussed in further detail below, when the connector carrier 100 has been mounted on a polishing fixture and the ferrules 230 protruding from the carrier 100 are ready for the polishing step, each latch insert 108 is urged toward a grinding board of a polishing machine independently of the other latch inserts 108. As such, the pressures of the tips of all of the ferrules 230 on the grinding board are substantially the same, regardless of the variation of the lengths of the ferrules 230 being polished. It should be noted that the spring constant of the coil springs 122 of the latch inserts 108 is smaller than the spring constant of the ferrule springs 234 that are within the LC connector housings 222.

As noted previously, the connector carrier 100 of the present disclosure may be provided as a traveling fixture that not only facilitates the ferrule polishing process but that can also be moved within a manufacturing facility among the different stations in terminating the optical fibers to the fiber optic connectors 220.

According to an example manufacturing process, the first step can be to latch a plurality of unterminated connector housings 222 (similar to that shown in FIGS. 19-21) to the connector carrier 100. At this step, each of the unterminated connector housings 222 generally includes the front housing portion 224 and a rear housing portion 226 with a ferrule assembly 228 captured therebetween. As noted above, the ferrule assembly 228 includes the ferrule 230, the hub 232, and the ferrule spring 234. When an unterminated LC connector housing 222 is being assembled, the ferrule hub 232 and the spring 234 are captured between the front housing portion 224 and the rear housing portion 226 of the connector housing 222 and a front end 238 of the ferrule 230 projects forward outwardly beyond a front end 240 of the connector housing 222, as noted above. The spring 234 is configured to bias the ferrule 230 in a forward direction relative to the connector housing 222.

When the unterminated connector housings 222 are within the connector carrier 100, a portion of the front housings 224 and the ferrules 230 protrude through the apertures 116 provided at the base portion 104 of the carrier 100, as illustrated in FIG. 29. The unterminated connector housings 222 may be loaded and latched to the carrier 100 manually one at a time.

The design of the connector carrier 100 that allows the front housings 224 and the ferrules 230 to at least partially protrude through the apertures 116 and be exposed to an exterior of the carrier 100 may facilitate certain aspects of the fabrication process. For example, as will be discussed below, certain process steps such as cleaving of the fibers may be performed without having to remove the connectors 220 from the carrier 100, using the carrier 100 itself as a fixture during this process step.

For the fabrication of the connectors, at the next step, the connector carrier 100 may be used to carry all of the unterminated connector housings 222 to an epoxy dispensing station, where an epoxy application needle may be used to dispense a preselected amount of epoxy for the securement of the optical fibers within the connectors 220.

After the optical fibers (e.g., the jacket and the strength layers) are stripped to a preselected length, exposing the buffer and glass layers, the connector carrier 100 can be moved to an insertion station where the stripped fibers can be inserted from a rear end 258 of the rear housing portion 226 into the ferrules 230. At the insertion station, the carrier 100 can be mounted to an insertion fixture for individual insertion of the optical fibers into the epoxy filled ferrules 230.

After curing of the epoxy and passing through a cooling station, the connector carrier 100 may be moved to a cleaving station, where the fibers protruding outwardly from the ends of the ferrules 230 may be cleaved to a length of around 50-100 microns from the ends of the ferrules 230.

The connector carrier 100 is now ready to be moved to a polishing station. The polishing station may comprise a polishing plate 130 that is part of a polishing fixture 132 to be used with a grinding apparatus or machine. The grinding apparatus may include a grinding board on which a grinding film is mounted. In certain examples, the grinding board is configured to travel in a combined polishing motion that includes revolutions on its own axis and movement throughout a preselected orbit. In certain other examples, simple rotation may be used.

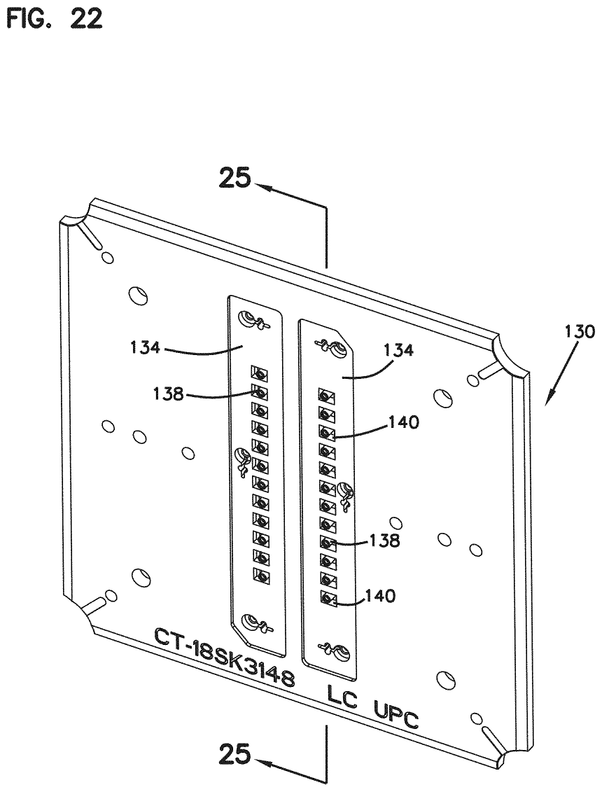

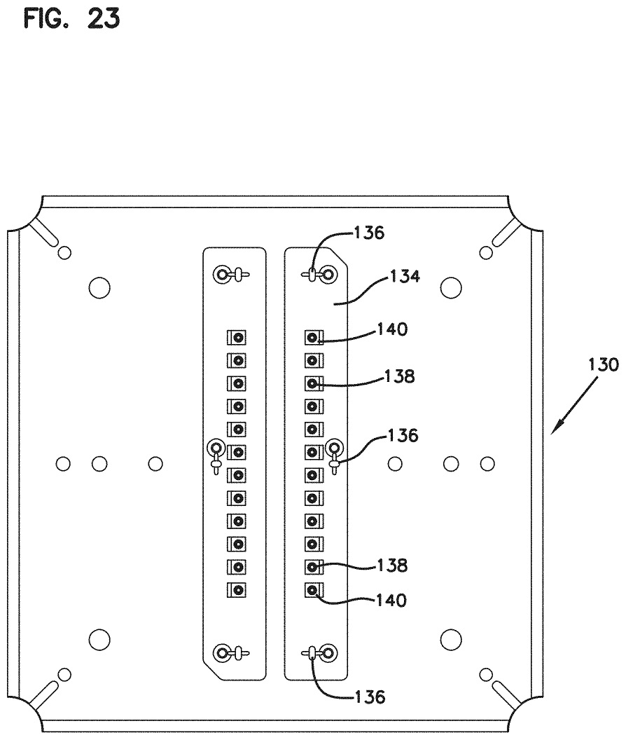

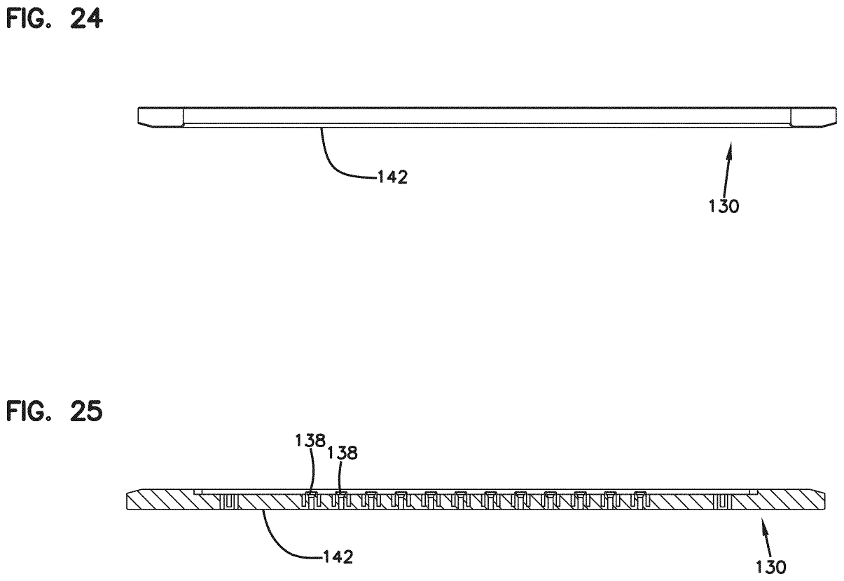

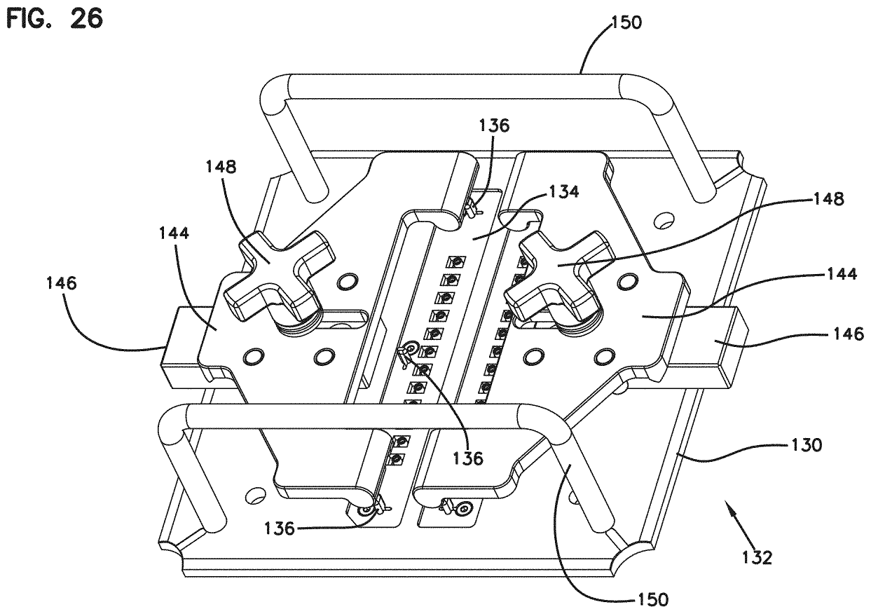

An example of a polishing plate 130 that is configured to receive the connector carrier 100 depicted in FIGS. 1-6 of the present application is shown in FIGS. 22-25. As noted above, the polishing plate 130 may be part of a polishing fixture 132 suitable for use with a grinding machine or apparatus. One example of such a polishing fixture 132 that is formed partially by the plate 130 of FIGS. 22-25 is shown in FIG. 26. The particular polishing fixture 132 has an outer geometry suitable for use with a grinding or polishing apparatus or machine manufactured and sold by Seikoh Giken Co., Ltd.

Referring back to FIGS. 22-25, the depicted polishing plate 130 is configured with two carrier receiving recesses 134. The recesses 134 are configured to position the carriers 100 in a side-by-side orientation, allowing two parallel rows of twelve LC style connectors 220 to be polished at the same time in a grinding apparatus.

As depicted, each recess 134 defines an outer perimeter that is shaped to receive the carrier 100 in a given orientation. The polishing plate 130 also defines further keying or guide features 136 for aligning with keying holes 137 provided at the bottom side 114 of the base portion 104 of the carriers 100.

As depicted, each recess 134 within the polishing plate 130 defines a plurality of ferrule sleeves 138 positioned within connector housing sub-recesses 140. When the carriers 100 are mounted to the polishing plate 130, the sub-recesses 140 accommodate the portions of the front housings 224 protruding from the carrier bases 104 while the ferrule sleeves 138 receive the protruding ferrules 130. The ferrule sleeves 138 provide stability to the ferrules 230 of the connectors 220 while allowing the ferrules 230 to protrude to the underside 142 of the polishing plate 130 for contact with the grinding film of the polishing apparatus.

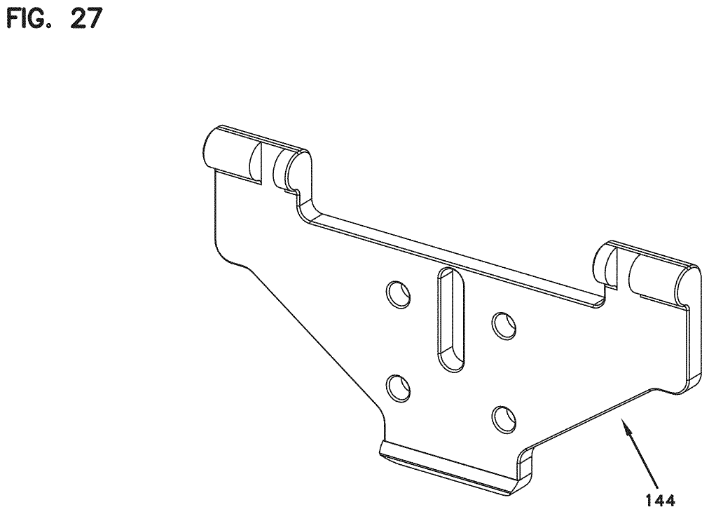

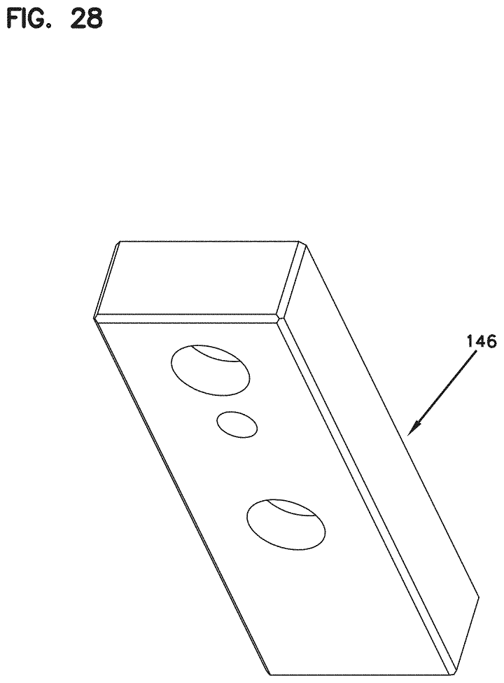

As shown in FIG. 26, once the carriers 100 are positioned within the recesses 134, a pair of clamps 144 may be provided to secure the carriers 100 onto the polishing plate 130. One of the clamps 144 is shown in FIG. 27. And, one of the clamp guides 146 used on the polishing fixture 132 of FIG. 26 when mounting the clamp members 144 is shown in FIG. 28. The clamp members 144 may be fixed to the polishing plate via fasteners 148, the guides 146 providing predefined spacing for the functionality of the clamps 144.

Handles 150 may also be provided on the polishing plate 130 for assistance with the placement and removal of the overall polishing fixture 132 to and from the grinding apparatus.

It should be noted that, while the polishing plate 130 depicted in FIGS. 22-26 is configured with geometry suitable for use with a grinding machine or apparatus manufactured and sold by Seikoh Giken Co., Ltd., other examples or types of polishing plates that can be used with grinding machines of other manufacturers are possible. The polishing plates, while designed with outer geometry suitable for such other machines, can still be provided with the same shaped carrier receiving recesses discussed above for universal use of the connector carriers 100 shown in FIGS. 1-6.

For example, FIG. 29 illustrates a polishing plate 330 that can be used with a grinding machine or apparatus manufactured and sold by NTT Advanced Technology Corporation. As shown, the polishing plate 330, while provided with an outer geometry suitable for an NTT Advanced Technology Corporation polishing fixture or apparatus, still defines carrier receiving recesses 334 suitable for receiving the connector carriers 100 shown in FIGS. 1-6 of the present application.

It should also be noted that the example of the connector carrier 100 shown in FIGS. 1-6 is used for the manufacturing process for LC style connectors 220, more specifically for an ultra-physical contact polishing operation as known in the art. In such an operation, as depicted, rows of twelve connectors 220 may be polished at the same time.

For an ultra-physical contact polishing operation involving SC style connectors, a similar carrier to that shown for the LC style connectors 220 may be used, but with a maximum of six SC connectors per row of two rows.

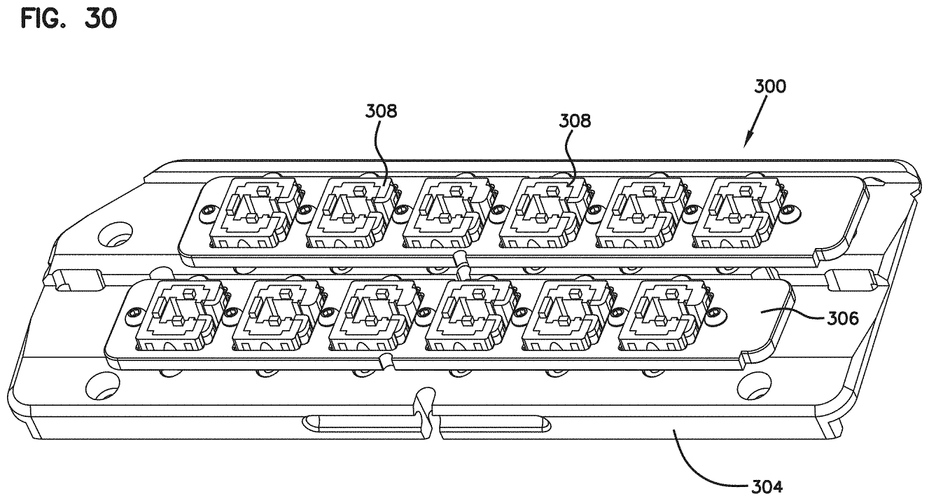

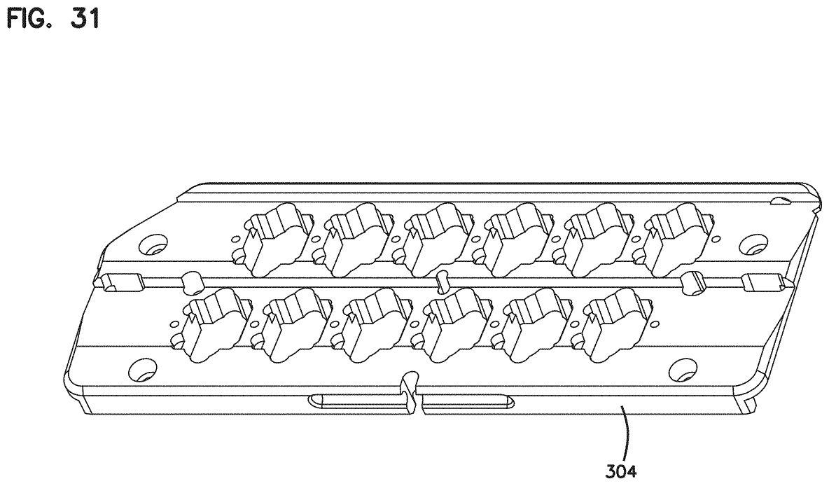

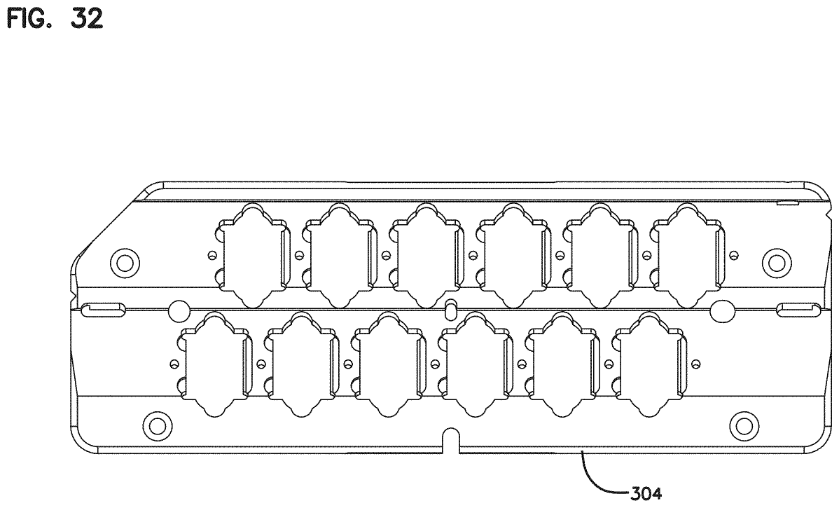

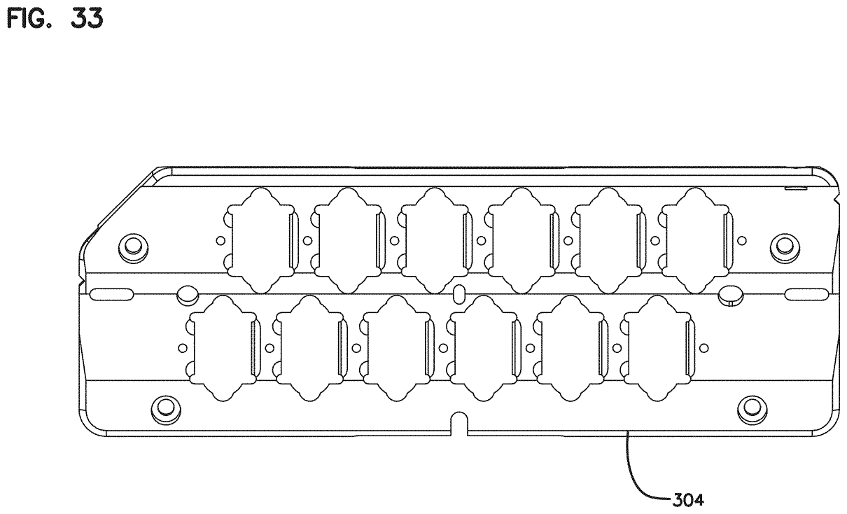

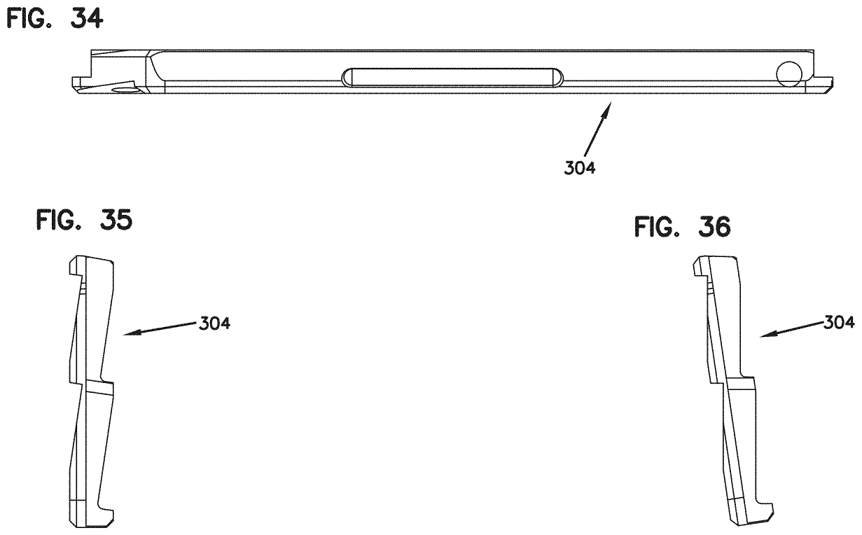

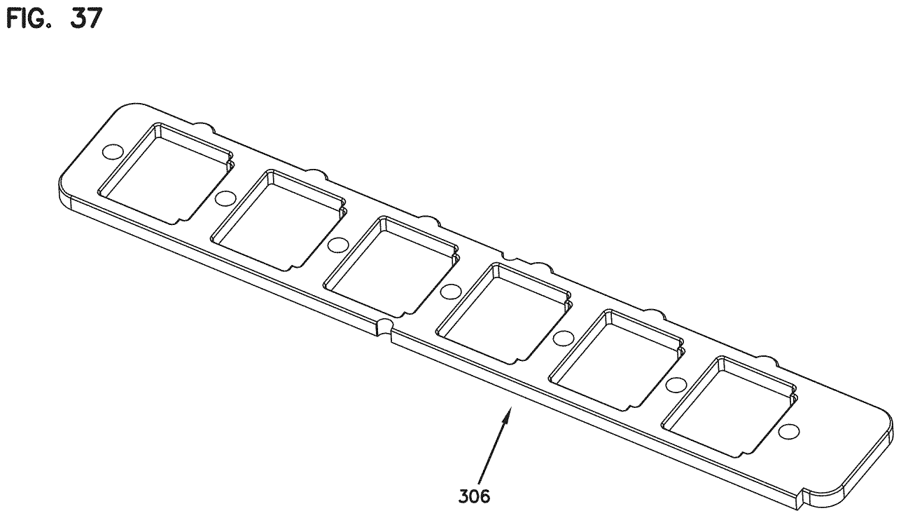

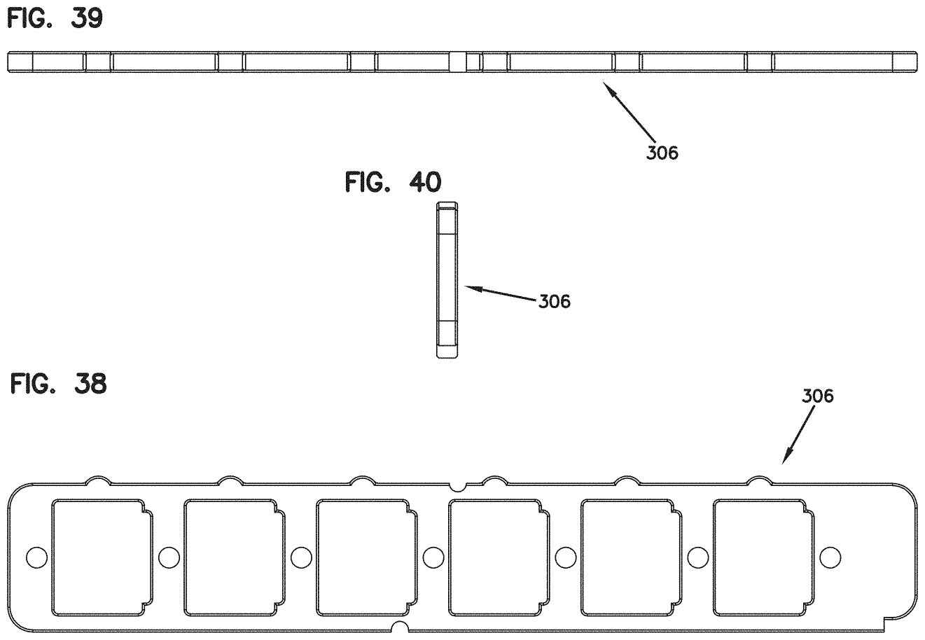

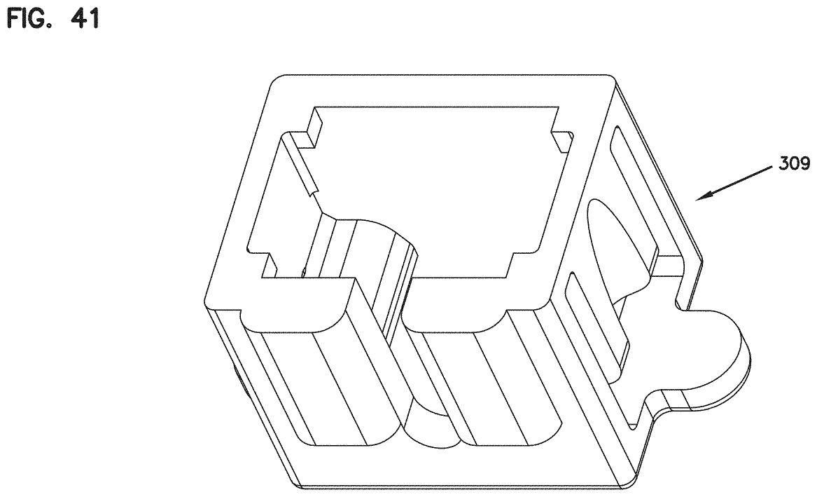

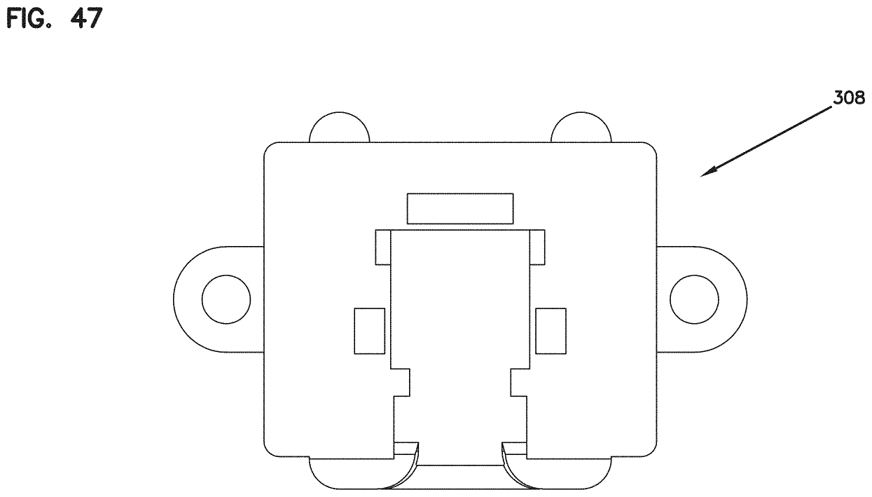

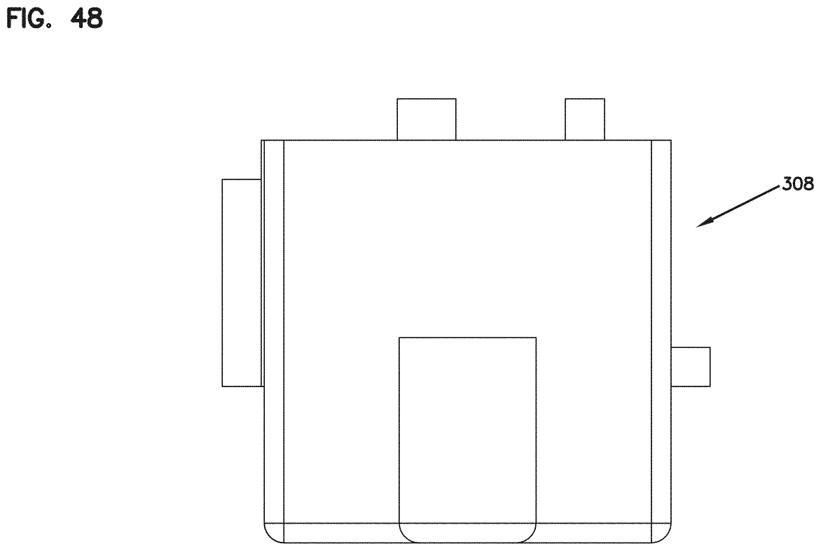

Referring now to FIG. 30, an example of an inventive carrier 300 for use with an angled physical contact polishing operation as known in the art is shown. In the depicted example, the carrier 300 is shown to be configured for LC style connectors. Similar to the carrier 100 of FIGS. 1-6 discussed above, the carrier 300 defines a base portion 304 (shown in FIGS. 31-36) and a cover portion 306 (shown in FIGS. 37-40) that captures LC clip inserts 308 (shown in further detail in FIGS. 45-48) thereinbetween.

The LC clip inserts 308, shown in FIGS. 45-48, are similar in function to the LC latch inserts 108 discussed above and are designed as partial LC adapters for holding LC connector housings. Similar to that discussed above, the LC clip inserts 308 are provided in a floating arrangement, biased toward the grinding film of a grinding apparatus with a pair of coil springs. As shown in FIGS. 30-36, the connector carrier 300 is provided with an offset, two-layer arrangement for the angled physical contact polishing. The angled physical contact carrier 300 for the LC style connectors includes six connectors per row of two rows.

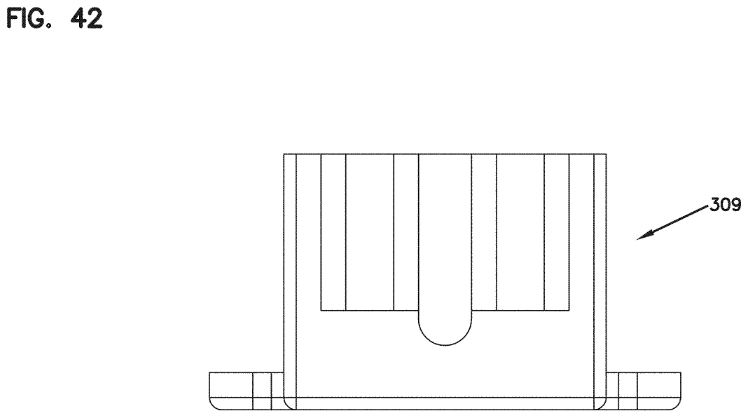

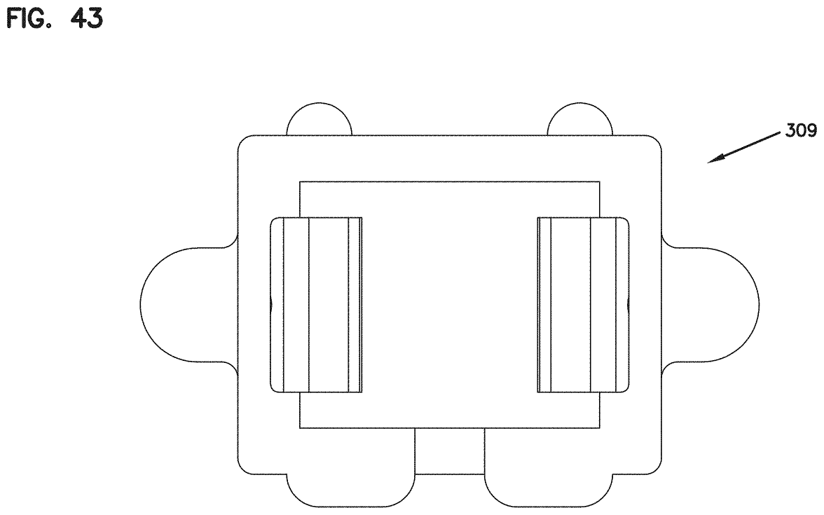

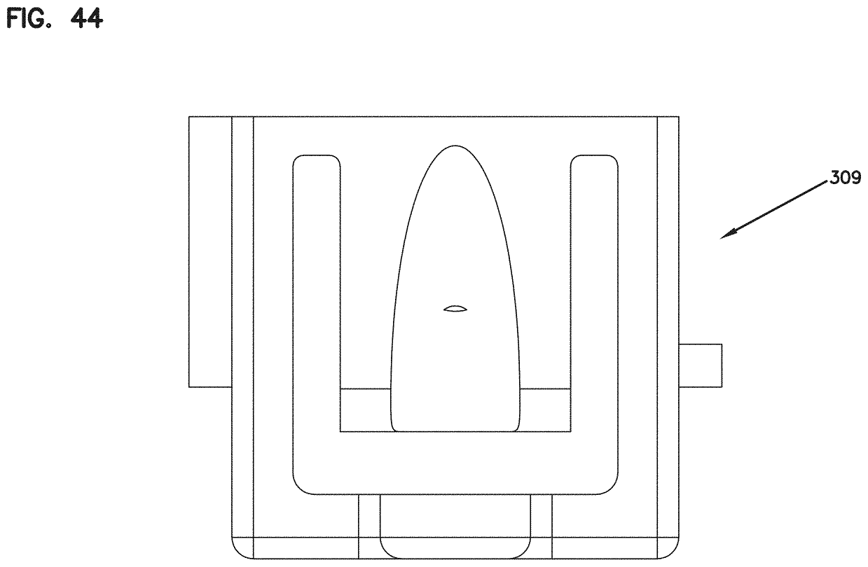

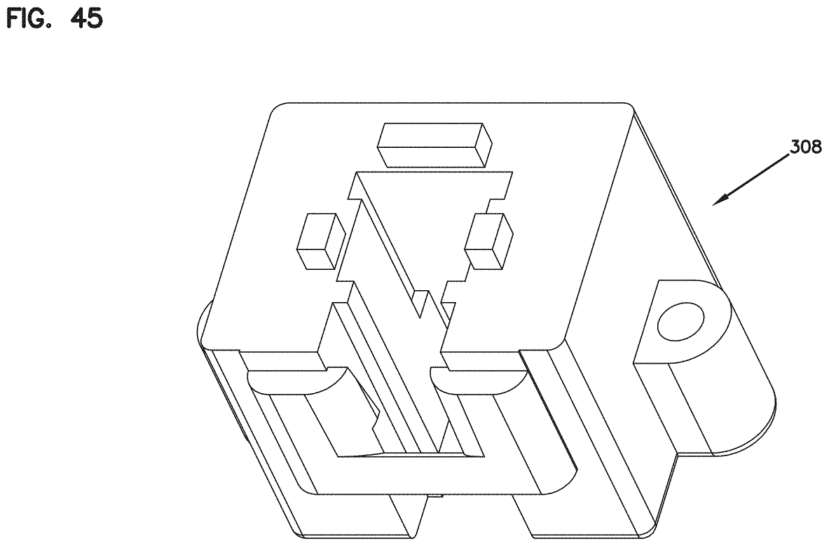

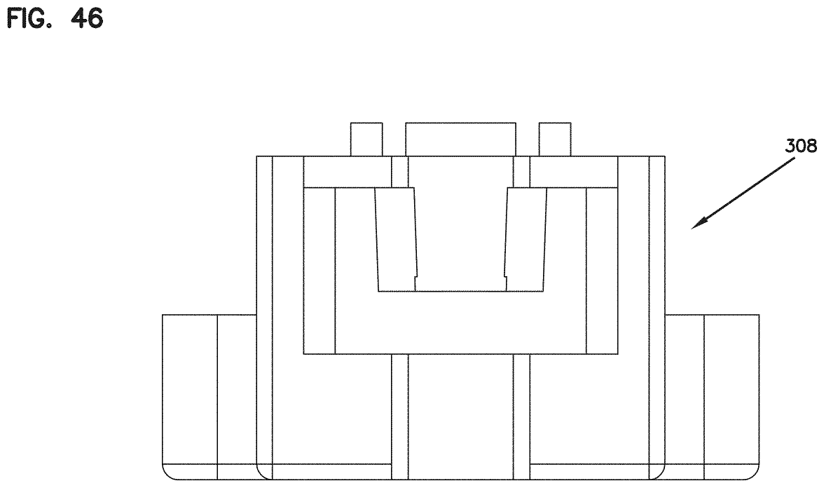

As an alternative example, views of an SC style insert latch 309 for use with an angled physical contact carrier 300 similar to that shown in FIGS. 30-40 is illustrated in FIGS. 41-44. Again, an angled physical contact carrier 300 for SC style connectors may normally include six connectors per row of two rows.

Although in the foregoing description, terms such as “top,” “bottom,” “front,” “back,” “right,” “left,” “upper,” and “lower” were used for ease of description and illustration, no restriction is intended by such use of the terms. The telecommunications devices described herein can be used in any orientation, depending upon the desired application.

Having described the preferred aspects and embodiments of the present disclosure, modifications and equivalents of the disclosed concepts may readily occur to one skilled in the art. However, it is intended that such modifications and equivalents be included within the scope of the claims which are appended hereto.

1. A fabrication carrier for fiber optic connectors, the carrier comprising:
a body configured to removably hold a plurality of fiber optic ferrules, the body allowing each of the fiber optic ferrules to be movable along its axis under a bias when the ferrules are mounted to the body, the body configured as a traveling fixture that can be moved within a manufacturing facility among different stations during fabrication of fiber optic connectors, wherein the body of the fabrication carrier is configured as a fixture that can be used in at least two separate fabrication steps used during manufacturing of a fiber optic connector, wherein the at least two separate steps are selected from the group consisting of cleaving of an optical fiber, epoxy application, insertion of an optical fiber into a fiber optic ferrule, curing of the epoxy, and polishing a fiber optic ferrule including the optical fiber.

2. A fabrication carrier according to claim 1, wherein the body defines a base portion and a cover portion that captures a plurality of latch inserts therebetween, each of the latch inserts configured to removably receive at least a portion of a fiber optic connector that includes the fiber optic ferrule with a snap-fit interlock.

3. A fabrication carrier according to claim 2, wherein the base portion defines a plurality of discrete apertures at a bottom face thereof, each configured to expose at least a portion of the fiber optic connector to be coupled to the carrier via the latch insert.

4. A fabrication carrier according to claim 2, wherein each of the latch inserts is spring-biased toward the base portion of the body.

5. A fabrication carrier according to claim 4, wherein each latch insert includes a pair of springs configured to contact the cover portion for providing the biased movement toward the base portion of the body.

6. A fabrication carrier according to claim 1, wherein the body is configured to removably hold at least portions of LC format fiber optic connectors for fabrication.

7. A fabrication carrier according to claim 1, wherein the body is configured to removably hold at least portions of SC format fiber optic connectors for fabrication.

8. A fabrication carrier according to claim 25, wherein the body defines an outer geometry configured to intermate with that of a recess provided on the polishing plate.

9. A fabrication carrier according to claim 25, wherein the body defines at least one keying member for orienting the carrier in a pre-selected orientation with respect to the polishing plate.

10. A fabrication carrier according to claim 25, wherein the body is not configured to be usable as a fixture with a ferrule polishing apparatus in a polishing step without the polishing plate.

11. A polishing fixture for use with a fiber optic ferrule polishing apparatus in a polishing step, the polishing fixture comprising:
a polishing plate defining a bottom face directed toward a grinding film of the polishing apparatus; and
a fabrication carrier for fiber optic connectors, the carrier comprising a body removably mounted to the polishing plate, the carrier configured to removably hold a plurality of fiber optic ferrules, the body allowing each of the fiber optic ferrules to be movable along its axis under a bias when the ferrules are mounted to the body, wherein when the fiber optic ferrules have been mounted to the carrier, each of the fiber optic ferrules at least partially protrudes past the bottom face of the polishing plate for contact with the polishing apparatus.

12. A polishing fixture according to claim 11, wherein the body of the fabrication carrier is configured such that the body can be removed and used as a stand-alone fixture in at least one additional fabrication step aside from the polishing step.

13. A polishing fixture according to claim 11, further comprising at least one clamp member for holding the fabrication carrier relative to the polishing plate.

14. A polishing fixture according to claim 11, further comprising at least one handle provided on the polishing plate.

15. A polishing fixture according to claim 11, wherein the polishing plate defines a recess configured to intermate with an outer geometry defined by the body of the fabrication carrier.

16. A polishing fixture according to claim 11, wherein the polishing fixture includes at least two separate fabrication carriers removably mounted to the polishing plate, each carrier configured to removably hold a plurality of fiber optic ferrules.

17. A polishing fixture according to claim 11, wherein the polishing plate defines a plurality of ferrule sleeves for receiving the fiber optic ferrules and allowing each of the ferrules to at least partially protrude past the bottom face of the polishing plate for contact with the polishing apparatus.

18. A polishing plate for use on a polishing fixture of a polishing apparatus, the polishing plate comprising:
a top face and an opposing bottom face configured to be directed toward a grinding film of the polishing apparatus;
a recess exposed on the top face for receiving a body of a fabrication carrier removably holding a plurality of fiber optic ferrules; and
a plurality of discrete ferrule sleeves defined within the recess, the ferrule sleeves configured to receive and allow the fiber optic ferrules to at least partially protrude past the bottom face of the polishing plate for contact with the grinding film of the polishing apparatus.

19. A fiber optic connector fabrication method, the method comprising:
removably coupling a connector carrier to a polishing plate, wherein the polishing plate defines a top face and an opposing bottom face configured to be directed toward a grinding film of a polishing apparatus and a recess exposed on the top face for receiving the connector carrier, wherein the connector carrier holds a plurality of fiber optic ferrules, the connector carrier allowing each of the fiber optic ferrules to be movable along its axis under a bias, wherein when the connector carrier is coupled to the polishing plate, each of the fiber optic ferrules at least partially protrudes past the bottom face of the polishing plate for contact with the grinding film of the polishing apparatus.

20. A method according to claim 19, further comprising coupling the connector carrier to the polishing plate after using the connector carrier in a previous fabrication step different than the polishing step.

21. A method according to claim 20, wherein the previous fabrication step includes cleaving of optical fibers carried by the connector carrier.

22. A method according to claim 19, further comprising removing the connector carrier from the polishing plate after the polishing step.

23. A fabrication carrier according to claim 1, wherein the at least two separate steps in which the fabrication carrier is configured to be used includes polishing a fiber optic ferrule that includes an optical fiber.

24. A fabrication carrier according to claim 1, wherein the at least two separate steps in which the fabrication carrier is configured to be used does not include polishing a fiber optic ferrule that includes an optical fiber.

25. A fabrication carrier according to claim 23, wherein the at least two separate steps in which the fabrication carrier is configured to be used includes polishing a fiber optic ferrule that includes an optical fiber and wherein the body of the fabrication carrier is configured for removable coupling to a polishing plate for use with a ferrule polishing apparatus in a polishing step, wherein coupling of the body to the polishing plate allows each of the fiber optic ferrules to at least partially protrude past a bottom face of the polishing plate for contact with the polishing apparatus, wherein the body of the fabrication carrier is configured as a fixture that can be used in at least one additional fabrication step aside from the polishing step when not mounted to the polishing plate.

26. A fabrication carrier for fiber optic connectors, the carrier comprising:
a body defining a top side, a bottom side, and a plurality of openings, each opening configured to removably receive at least a portion of a fiber optic connector outer housing with a fiber optic ferrule within the fiber optic connector outer housing in a direction from the top side toward the bottom side, wherein the body of the fabrication carrier is configured to allow each of the fiber optic outer housings to be movable along its axis under a bias when the fiber optic outer housings are mounted to the body, wherein the fabrication carrier is configured such that when the fiber optic connector outer housings are mounted to the body of the fabrication carrier, at least a portion of the outer housing of each fiber optic connector as well as at least a portion of the fiber optic ferrule surrounded by the outer housing protrude past the bottom side of the body so as to be exposed from the bottom side of the body.

27. A fabrication carrier according to claim 26, wherein the body is configured for removable coupling to a polishing plate for use with a ferrule polishing apparatus in a polishing step, wherein coupling of the body to the polishing plate allows each of the fiber optic ferrules to at least partially protrude past a bottom face of the polishing plate for contact with the polishing apparatus, wherein the fiber optic connector outer housings do not protrude past and are not exposed from the bottom face of the polishing plate.

28. A fabrication carrier according to claim 26, wherein the body defines a base portion and a cover portion that captures a plurality of latch inserts therebetween, each of the latch inserts configured to removably receive at least a portion of the fiber optic connector outer housing that includes the fiber optic ferrule with a snap-fit interlock.

29. A fabrication carrier according to claim 28, wherein the base portion defines a plurality of discrete apertures at the bottom side of the body, each configured to expose at least a portion of the fiber optic connector outer housing to be coupled to the carrier via the latch insert.

30. A fabrication carrier according to claim 28, wherein each of the latch inserts is spring-biased toward the base portion of the body.

31. A fabrication carrier according to claim 30, wherein each latch insert includes a pair of springs configured to contact the cover portion for providing the biased movement toward the base portion of the body.

32. A fabrication carrier according to claim 26, wherein the body is configured to removably hold at least portions of outer housings of LC format fiber optic connectors for fabrication.

33. A fabrication carrier according to claim 26, wherein the body is configured to removably hold at least portions of outer housings of SC format fiber optic connectors for fabrication.

34. A fabrication carrier according to claim 27, wherein the body defines an outer geometry configured to intermate with that of a recess provided on the polishing plate.

35. A fabrication carrier according to claim 27, wherein the body defines at least one keying member for orienting the fabrication carrier in a pre-selected orientation with respect to the polishing plate.

36. A fabrication carrier according to claim 27, wherein the body is not configured to be usable as a fixture with a ferrule polishing apparatus in a polishing step without the polishing plate.
